(19) United States
(12) Patent Application Publication
(10) Pub. No.: US 2004/0032140 A1
(43) Pub. Date: Feb. 19, 2004

(54) Remote control connecting device for lifting device

(76) Inventor: Lars Magnus Solstad, Skudeneshavn (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/218,758

(22) Filed: Aug. 14, 2002

(51) Int. Cl. B66C 13/08

(52) U.S. Cl. 294/82.15; 294/81.4

(57) ABSTRACT

A device for remotely controlled pick-up, connection and disconnection of for example a coupling ring (52) of a lifting straddle (50) to a lifting hook (6) of a lifting device (2), wherein a positioning/pick-up device (1) is connected to a lifting wire (4) of the lifting device (2).

This invention regards a device for facilitating remotely controlled pick-up and connection/disconnection of e.g. the coupling ring of a lifting straddle to/from the lifting hook of a crane, especially when lifting containers and lengths of piping such as is common in connection with offshore petroleum production.

When lifting containers and other equipment equipped with lifting straddle for lifting from a supply ship to an offshore installation, the coupling ring must normally be connected manually to the lifting hook.

The manual connecting operation may be physically demanding and in some cases dangerous, especially when the work is carried out under adverse weather conditions.

According to prior art pertaining to containers, the coupling ring of a lifting straddle is arranged so as to be suspended along one of the container side walls during transport, in order obviate the need for someone to climb up on the container during the connecting operation.

The object of the invention is to remedy the disadvantages of prior art.

The object is achieved in accordance with the invention by the characteristics stated in the description below and in the appended claims.

A positioning/pick-up device is rotatably connected to and encircles a lifting wire immediately above the lifting hook of the lifting wire. The positioning/pick-up device comprises a frame connected to the lifting wire via at least one bearing and a mounting tube/wire clamp. The frame is designed to be able to rotate about the wire in the horizontal plane by means of an electrically or mechanically driven propeller connected to the frame. A releasable braking device is designed to prevent inadvertent rotation between the frame and the lifting wire.

The frame is equipped with at least one magnetic foot that may be displaced vertically relative to the frame, and at least one loop retriever that may be displaced vertically relative to the frame.

The positioning/pick-up device is supplied with energy and controlled from the crane to which it is connected. Means such as video cameras, laser range finders and automatic heave compensating may be used to facilitate the use of the positioning/pick-up device.

When a container or other item is to be lifted, the positioning/pick-up device is lowered towards the container and rotated to an appropriate horizontal orientation by means of the propeller. The lifting hook of the crane/lifting device may be fixed relative to the frame by using the brake.

One of the magnetic feet is moved down to the top surface of the container, where the magnet is attracted by the magnetic material of the container so that a relatively strong connecting force arises between the magnetic foot and the container.

One of the loop retrievers is displaced downwards and manoeuvred so as to couple it to the coupling ring/lifting equipment by means of e.g. a magnet or hook, whereupon the coupling ring/lifting equipment is placed in the lifting hook of the crane by means of the loop retriever.

The lifting hook may be equipped with a remotely controlled hook lock according to the current regulations.

In an alternative embodiment, the lifting wire of the crane may be equipped with e.g. a hook/loop connector immediately above the positioning/pick-up device in order to allow easy uncoupling of the device from the crane.

The following describes a non-limiting example of a preferred embodiment illustrated in the accompanying drawings, in which:

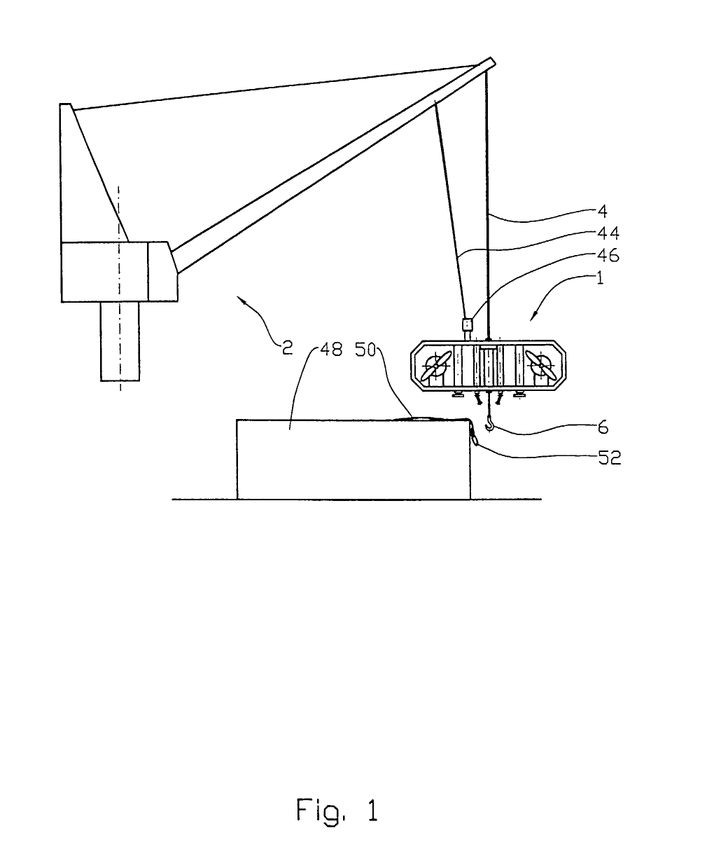

FIG. 1 is a schematic diagram of a crane, to the lifting wire of which is connected a positioning/pick-up device, and where the positioning/pick-up device is located in a position immediately above a container to be lifted;

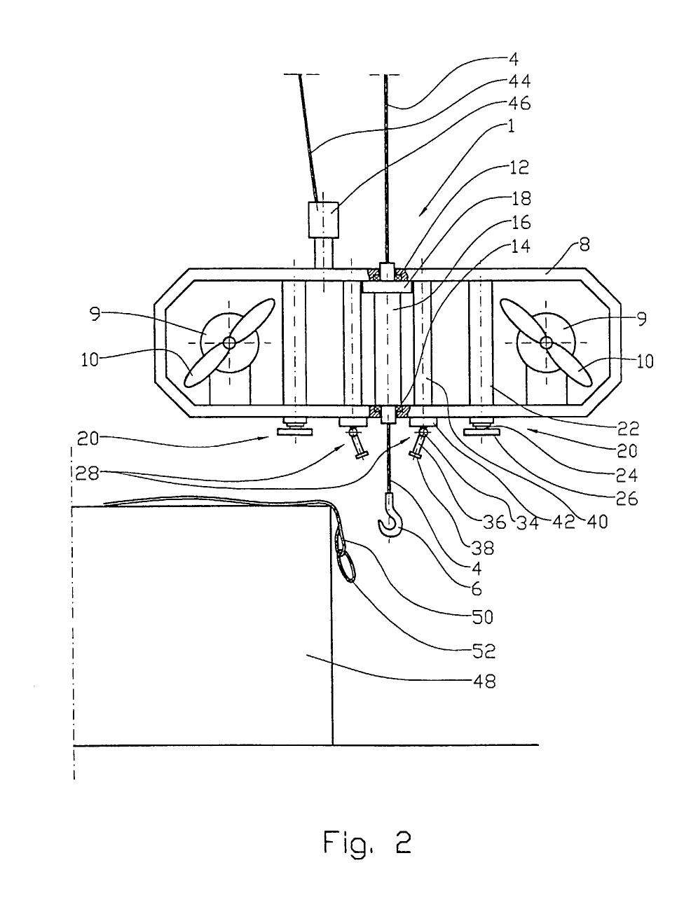

FIG. 2 is a schematic diagram similar to FIG. 1, but on a larger scale;

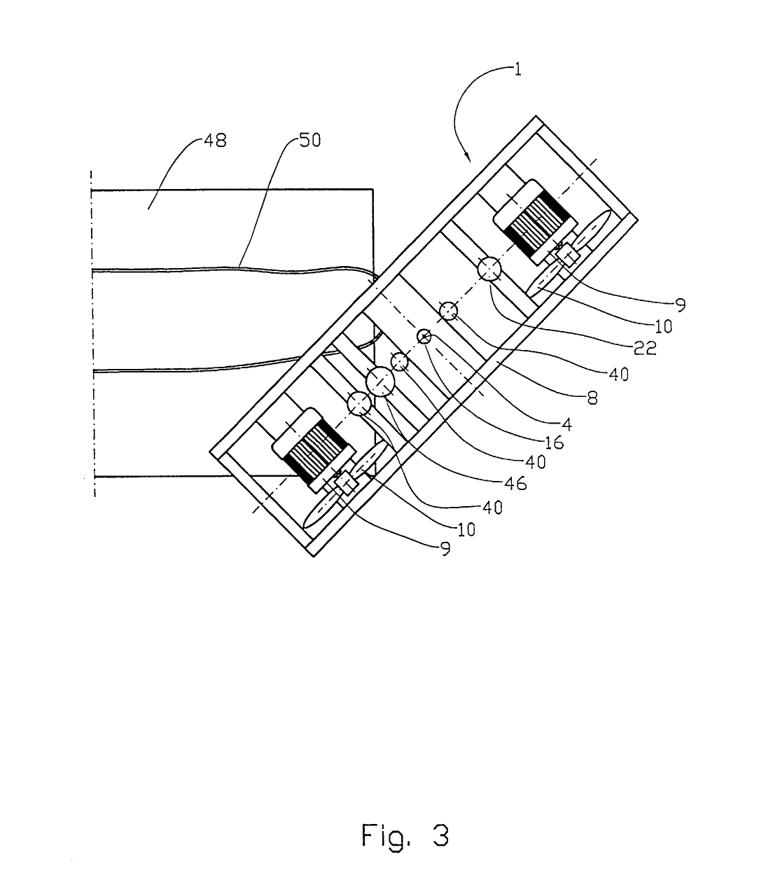

FIG. 3 is a plan view of the positioning/pick-up device and the container, where a propeller is in operation to rotate the positioning/pick-up device to the desired horizontal orientation;

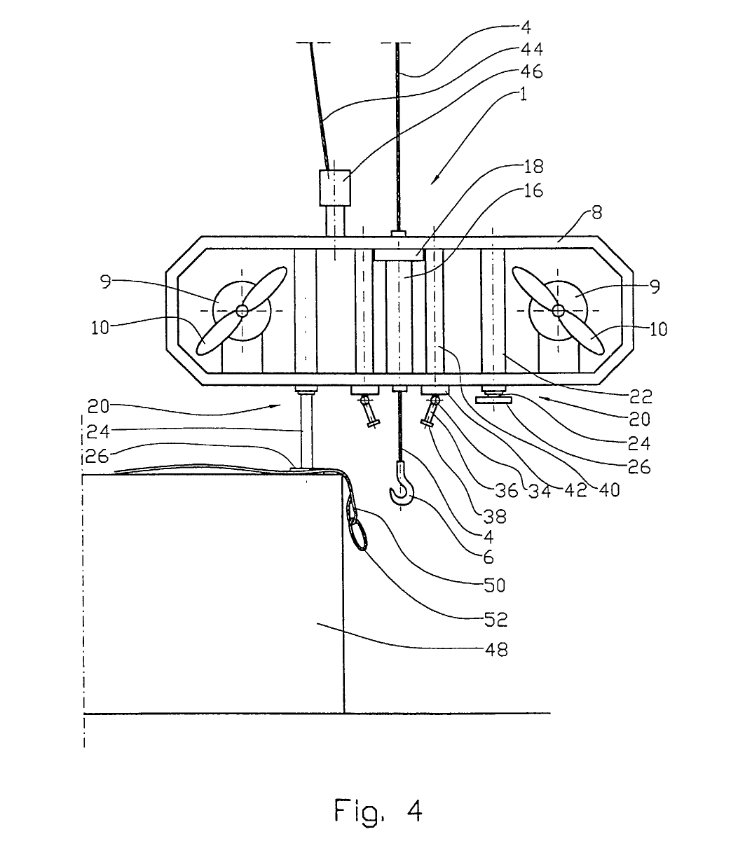

FIG. 4 shows the same as FIG. 2, but here, one of the magnetic feet has been moved down to the top surface of the container, whereby the magnetic foot connects the positioning/pick-up device to the container;

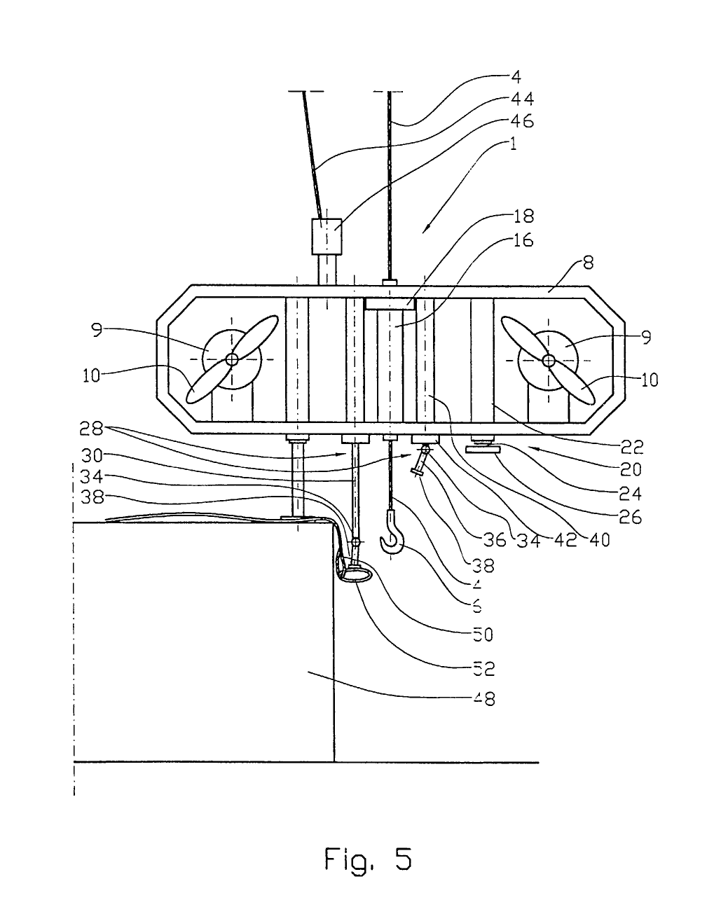

FIG. 5 shows the same as FIG. 4, but here, the loop retriever of the positioning/pick-up device has pulled in the coupling ring of the container;

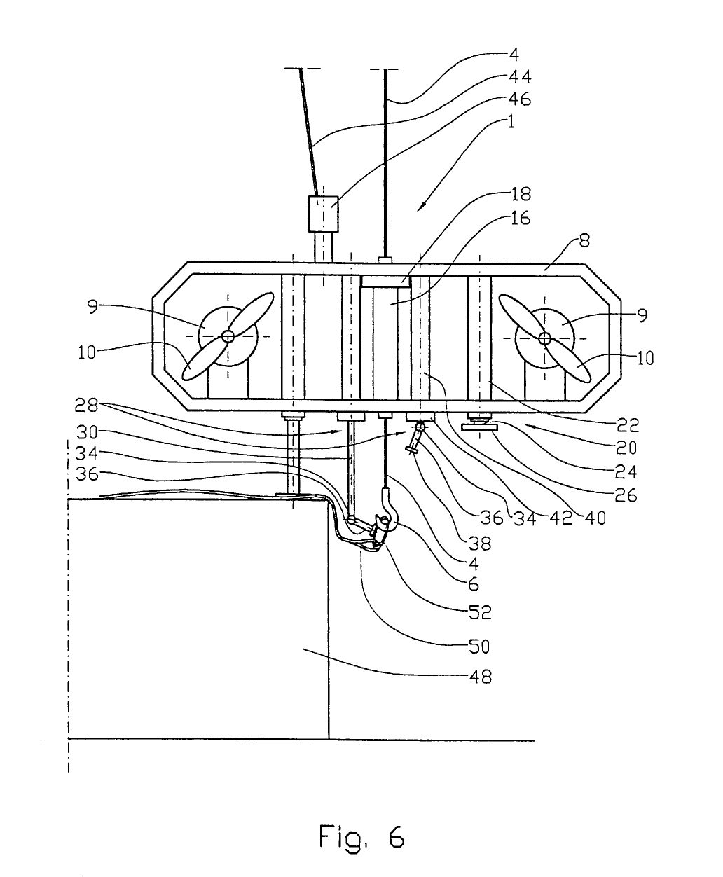

FIG. 6 shows the same as FIG. 5, but here, the loop retriever of the positioning/pick-up device has placed the coupling ring in the lifting hook of the crane; and

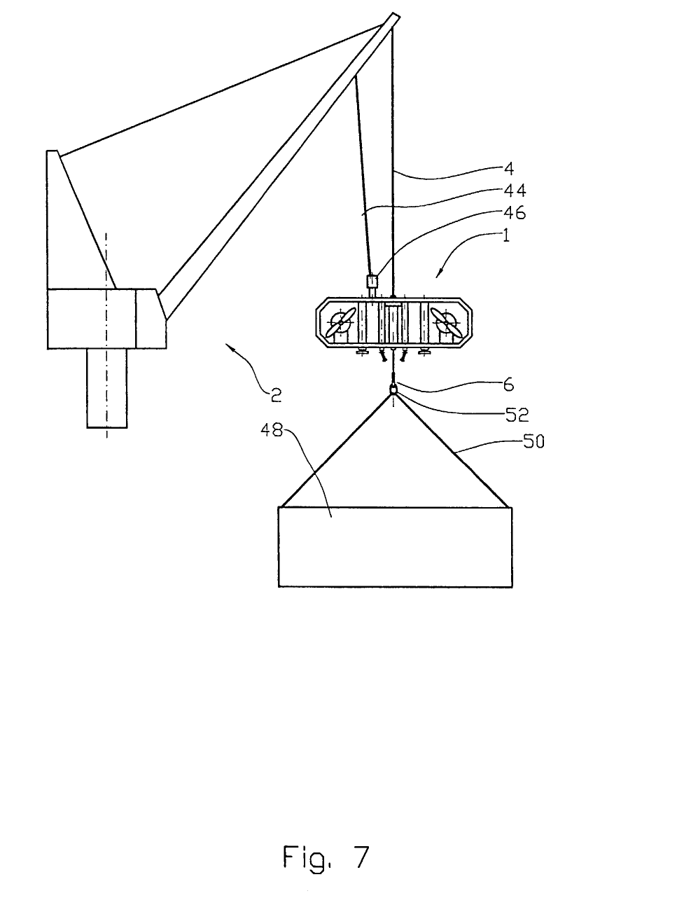

FIG. 7 shows the same as FIG. 1, but here, the container has been lifted up.

In the drawings, reference number 1 denotes a positioning/pick-up device rotatably connected to the lifting wire 4 of a crane 2, immediately above the lifting hook 6 of the crane 2.

The positioning/pick-up device 1 comprises a frame 8 where, at a distance from the lifting wire 4, there is provided a propeller 10 connected to an electric or combustion motor 9. The propeller 10 is designed to rotate the positioning/pick-up device in the horizontal plane. The frame 8 is rotatably connected to a mounting tube/wire clamp 16 via an upper bearing 12 and a lower bearing 14, where the mounting tube/wire clamp 16 is rigidly mounted to and encircles the lifting wire 4 by means of techniques that are known per se.

A releasable braking device 18 of a type that is known per se is provided between the mounting tube/wire clamp 16 and the frame 8. The braking device 18 is designed to prevent inadvertent rotation between the mounting tube/wire clamp 16 and the frame 8.

The positioning/pick-up device 1 is balanced w.r.t. weight, so that it assumes a horizontal position and remains horizontal when suspended from the lifting wire 4.

At a distance from the lifting wire 4, the positioning/pick-up device 1 is equipped with at least one horizontally rotatable magnetic foot 20 that may be displaced vertically relative to the frame. The magnetic foot 20 is made up of the piston rod 24 of a hydraulic cylinder 22, which at its free end portion is provided with an electromagnet 26 or other appropriate magnet.

At least one loop retriever 28 is positioned relatively near the lifting wire 4 and the lifting hook 6. In a preferred embodiment, the loop retriever 28 comprises a spindle 30 that is rotatable in the horizontal plane and may be displaced vertically relative to the frame 8, the lower end portion of which spindle is equipped with a preferably electrically controlled turn actuator 34. One end portion of a lever 36 is connected to the turn actuator 34, whereby the lever 36 is designed to rotate in the vertical plane about the rotational axis of the turn actuator 34. At the opposite end portion, the lever 36 is equipped with a magnet 38.

The spindle 30 is displaced vertically by an actuator 40, preferably in the form of a hydraulic cylinder, and is rotated about its vertical axis by a turn motor 42, e.g. via longitudinal grooves (not shown) in the spindle 30.

The lifting hook 6 may be equipped with a remotely controlled hook lock (not shown) of a type that is known per se.

The positioning/pick-up device 1 is supplied with electrical is energy via a cable 44 and a slip ring contact 46. The positioning/pick-up device 1 may be operated from the crane 2 through e.g. radio connection to a control system (not shown) of a type that is known per se, positioned in the frame 8.

When a container 48 or other package is to be lifted, the container must be coupled to the lifting hook 6 by means of a lifting straddle 50 with an associated coupling ring 52. As mentioned above, during sea transport the coupling ring 52 is arranged suspended along one of the side walls 48 of the container. Lifting straddle 50 and coupling rings 52 belonging to other packages may be located on the top of the package or be placed next to the package.

The lifting hook 6 and the positioning/pick-up device 1 are lowered to a position in close proximity to the coupling ring 52, see FIGS. 1 and 2. The lifting hook 6 and the positioning/pick-up device 1 are rotated to a desired position in the horizontal plane by starting at least one of the motors 9, whereby the associated propeller 10 causes the positioning/pick-up device 1 and the lifting hook 6, which via the lifting wire 4, the mounting tube/wire clamp 16 and the braking device 18 is rotationally connected to the positioning/pick-up device 1, to rotate together about the axis of the lifting wire 4. See FIG. 3.

Particularly in bad weather, when the package for lifting may as a result of the motion of the sea go through considerable heaving motion, it is preferable to connect the positioning/pick-up device 1 to the container 48 during the connecting operation.

The piston rod 24 of a magnetic foot 20 and the associated electromagnet 26 are moved down to the container, see FIG. 4, whereupon electrical voltage from the control system (not shown) is applied to the electromagnet 26. The magnetic forces between the container 48 and the electromagnet 26 cause the electromagnet 26 to attach to the container 48 with a relatively great force. Advantageously, the underside of the electromagnet 26 is equipped with a shock absorber (not shown) designed to ensure that the impact with the container 48 does not cause damage to the electromagnet 26.

In good weather conditions with moderate seas, the heave compensating device of the crane 2 may by means of e.g. a range finder (not shown) that measures the distance between the positioning/pick-up device 1 and the container 48, maintain a sufficiently accurate distance between the positioning/pick-up device 1 and the container 48 for the connection to take place without use of the magnetic foot 20.

The spindle 30 of the loop retriever 28 is displaced vertically by means of the actuator 40 and is rotated in the horizontal plane by the turn motor 42, so that the magnet 38 of the lever 36 may be brought into contact with the coupling ring 52 through the lever 36 being rotated in the vertical plane by the turn actuator 34, see FIG. 5.

The coupling ring 52 is then placed in the lifting hook 6, the loop retriever 28 with the attached coupling ring 52 being manoeuvred into an appropriate position, see FIG. 6. The magnet 38 of the loop retriever 28 is then pulled away from the coupling ring 52 with sufficient force to make it release the coupling ring 52.

The disconnection of the coupling ring 52 from the lifting hook 6 may take place in the same way as the connection, but in reverse order.

When the container 48 is to be positioned in a location with restricted space, the positioning/pick-up device 1 may have to be straightened up relative to the container 48, as the longitudinal axis of the positioning/pick-up device 1 deviates significantly from that of the container 48. By releasing the braking device 18 and starting one of the motors 9, the corresponding propeller 10 causes the positioning/pick-up device 1 to rotate about the lifting wire 4 to the desired position, whereupon the braking device 18 is re-engaged.

Use of a positioning/pick-up device according to the invention allows considerable improvement of the working environment surrounding lifting operations, as one of the most dangerous operations connected with the lifting may be remotely controlled.

1. A device for facilitating remotely controlled pick-up and connection/disconnection of a piece of lifting equipment (50, 52) to/from the lifting hook (6) of a lifting device (2), comprising a positioning/pick-up device (1), where the positioning/pick-up device (1) is designed to be able to rotate about the lifting wire (4) of the lifting device (2) in a controlled manner, characterised in that the positioning/pick-up device (1) is equipped with one or more loop retrievers (28) that is/are rotatable and/or displaceable in at least one direction or plane.

2. A device in accordance with claim (1), characterised in that the connecting element (38) of the loop retriever (28) for connecting to the lifting equipment (50, 52) comprises a magnet.

3. A device in accordance with one or more of the preceding claims, characterised in that the connecting element (38) of the loop retriever (28) for connecting to the lifting equipment (50, 52) comprises a hook device.

4. A device in accordance with one or more of the preceding claims, characterised in that the positioning/pick-up device (1) is equipped with at least one propeller (10), and where the propeller (10), which is driven by a motor (9), is designed to rotate the positioning/pick-up device (1) about the central axis of the lifting wire (4).

5. A device in accordance with one or more of the preceding claims, characterised in that the positioning/pick-up device (1) is equipped with a releasable braking device (18) arranged between the frame (8) of the positioning/pick-up device (1) and a mounting tube/wire clamp (16) rigidly mounted to the lifting wire (4).

6. A device in accordance with one or more of the preceding claims, characterised in that the positioning/pick-up device (1) is equipped with at least one magnetic foot (20).

7. A device in accordance with one or more of the preceding claims, characterised in that the magnetic foot (20) may be displaced vertically relative to the frame (8).

8. A device in accordance with one or more of the preceding claims, characterised in that the magnet (26) of the magnetic foot (20) is constituted by an electromagnet.
